(19) United States
(12) Patent Application Publication
(10) Pub. No.: US 2026/0346818 A1
(43) Pub. Date: Nov. 5, 2026

(54) ELECTROMECHANICAL BRAKE SYSTEM FOR A MOTOR VEHICLE WITH YAWING MOMENTUM RESTRICTION

(71) Applicant: Continental Automotive Technologies GmbH, Hannover (DE)

(72) Inventors: Sascha Gröger, Idstein (DE); Jürgen Böhm, Oberneisen (DE); Matthias Muntu, Hofheim am Taunus (DE)

(73) Assignee: Continental Automotive Technologies GmbH, Hannover (DE)

(21) Appl. No.: 19/134,712

(22) PCT Filed: Dec. 1, 2023
(86) PCT No.: PCT/DE2023/200239

§ 371 Date: Jun. 15, 2026

(30) Foreign Application Priority Data
Dec. 1, 2022 (DE) 10 2022 212 959.8

(51) Int. Cl. B60T 8/174; B60T 8/171; B60T 8/172; B60T 8/58; B60T 13/74

(52) U.S. Cl. CPC B60T 8/174; B60T 8/171; B60T 8/172; B60T 8/58; B60T 13/746; B60T 2220/03; B60T 2220/04; B60T 2240/00; B60T 2250/04

(57) ABSTRACT

A method for controlling an electromechanical wheel brake of a motor vehicle by way of a local wheel brake control unit associated with the wheel brake, wherein the wheel brake control unit is connected via a data connection to a central brake control unit of the motor vehicle comprises ascertaining a brake demand from actuating information of a brake actuating unit and transmitting wheel-individual control signals corresponding to the brake demand to the local brake control units of the wheel brakes, wherein the corresponding control signal can be converted into a wheel-individual modified control signal at least for one wheel.

### TECHNICAL FIELD

The embodiments relate in general to an electromechanical brake system for a motor vehicle and to a method for operating such an electromechanical brake system for a motor vehicle.

### BACKGROUND

In electromechanical wheel brakes, in general the brake pedal is decoupled from the brake system and the wheel brakes are designed as electromechanically actuated wheel brakes. The brake pedal is designed to detect a deceleration request of the driver.

When the mechanical connection of the brake pedal to the wheel brakes is decoupled, an external power supply is required that generates a braking torque or clamping force for actuating the wheel brake independently of the driver force. Furthermore, it is necessary to regulate the braking torque or brake application force of the individual wheel brakes in dependence on the driver request. For this purpose, it is also necessary to detect the actuation of the brake pedal by the driver using sensors. This can take place in a known manner, for example, by redundant measurement of the brake pedal travel or the driver foot force, wherein a driver braking request for the electromechanical brake system can be generated from this information.

Since there is a risk of faults in technical systems, which under unfavorable circumstances could result in a reduction of the braking capacity and therefore in hazardous situations, it is to be ensured accordingly by a suitable system architecture that the driver braking request is also ascertainable in case of fault and is implementable using the available brake actuators.

In document DE 10 2020 213 130 A1 of the applicant, a brake system for a motor vehicle is specified having an arrangement for determining the setpoint values for the deceleration request on the basis of a driver actuation. A method is described which is still capable, for example, in the event of failure of a wheel brake or a local brake control unit, of forming a deceleration request for the remaining wheel brakes which are still functional, so that the vehicle remains controllable upon the brake actuation.

Elements of the brake system are designed redundantly, so that, for example, in the event of a failure of the central brake control unit, in a fallback level the brake system still remains capable of passing on actuation information detected by the brake actuating device to the wheel brakes. Provided the redundancy is carried out with maximum independence of the relevant elements, this results in a large number of elements or data connections. A third data connection can thus be provided in a ring structure, for example, which networks local brake control units with one another in a fallback level.

Independently of the redundancy of specific elements of the brake system, it is to be taken into consideration, in particular in the event of failure of a front wheel brake, that the force buildup on the remaining intact wheel brake takes place such that possibly occurring yawing momentum, which can arise if the vehicle rotates around the vertical axis, remains controllable for a driver.

A method is described for this purpose in document DE 10 2020 213 130 A1, in which the driving stability of the vehicle can be improved in general in case of a failure of a local brake control unit by limiting the increase of the setpoint deceleration of the vehicle to a specific gradient.

However, in this case a strong limiting of the increase of the vehicle deceleration request takes place where possible and therefore strong limiting of the braking torques to be applied, so that a braking distance lengthens excessively.

Accordingly, a brake system for a vehicle is desirable which reduces or does not have these challenges.

In particular only the least possible limiting of the braking torques to be applied is to take place, in order to provide the greatest possible level of safety during a braking operation. Also, driving stability should be retained as much as possible.

### SUMMARY

This object is achieved by a brake system for a motor vehicle and a method for operating such a brake system

In a first aspect, a brake system for a motor vehicle comprises electromechanical wheel brakes, a brake actuating unit, and at least one central brake control unit, wherein the wheel brakes each have a local brake control unit, the central brake control unit is directly connected to the brake actuating unit and the local brake control units of the wheel brakes via at least one data connection, wherein the central brake control unit is designed, in a normal operating mode of the brake system, to ascertain at least one brake demand from the actuation information of the brake actuating unit and to transmit wheel-individual control signals corresponding to the brake demand to the local brake control units of the wheel brakes, wherein in operation, at least for one electromechanical wheel brake, the corresponding control signal can be converted into a wheel-individual modified control signal, and wherein the ascertainment of the wheel-individual modified control signal is based on a wheel-individual scaling factor or comprises a wheel-individual scaling factor.

A motor vehicle may refer to a vehicle that has axles, wherein at least one of these axles comprises steerably guided wheels and, furthermore, the driving of the wheels on at least one axle is adaptable in a wheel-specific manner.

The brake system can comprise electromechanical wheel brakes, also designated as EMB (“EMB”=electromechanical brake), wherein for example all wheel brakes of the motor vehicle can be designed as electromechanical or electrically actuatable wheel brakes.

The brake system may be designed as a service brake. However, it is also possible to use the brake system together with a parking brake.

The electromechanical wheel brakes can be embodied as electromechanical disk brakes, in which a clamping force or brake application force can be produced by means of an electric motor, an auxiliary transmission, and/or a rotation/translation mechanism. In this context, the brake application force refers to the force with which the brake linings are pressed against the brake disk. During operation, a corresponding braking torque is then produced at the wheel under consideration in this way. Depending on the embodiment and control concept, the control system can be selected in such a way that either a specified, defined clamping force or a specified, defined braking torque is set in accordance with the deceleration demand requested.

The electromechanical wheel brakes can also be designed as an electromechanical drum brake, in which the motor/transmission unit actuates an expansion module, which presses the brake linings against the brake drum with an expansion force determined on the basis of the requested deceleration request and thus produces a corresponding braking torque. Depending on the embodiment and control concept, the actuation can be embodied in such a way that a defined expansion force or a defined braking torque is set in accordance with the deceleration request.

The brake actuating unit may be an electrical brake pedal. Such an electrical brake pedal, also referred to as an ePedal, typically has a brake actuating unit for actuation by a vehicle driver, wherein a reset device acts on the brake actuating unit. The degree of the actuation of the brake actuating unit is sensorially detected here, for example, in the form of an actuating travel, an actuating angle, and/or an acting actuating force, wherein an actuating signal is generated from the detected sensor variables. The brake system can then be actuated on the basis of the actuation information of the brake actuating unit.

The actuation information may comprise a degree of actuation of the brake actuating unit, for example an actuating angle, an actuating travel, or an actuating force, or the brake demand as such. Direct transmission of the brake demand as the actuating information can be provided, for example, for automated driving functions, since no mechanical data of a brake pedal are necessary here, but rather information about a deceleration to be applied can be provided by a driving function. The designation as “actuating information” accordingly does not refer exclusively to the actuation of a brake pedal, but rather to an actuation of the brake as such.

The brake actuating unit can be connected directly to the central brake control unit for this purpose via at least one data connection.

The central brake control unit can be designed, in a normal operating mode of the brake system, to ascertain at least one brake demand from the actuation information of the brake actuating unit obtained via the data connection and to transmit control signals corresponding to the brake demand to the local brake control units of the wheel brakes.

The central brake control unit can be provided here as the central point of a radial connection, so that the central brake control unit is connected directly, that is to say immediately, to the brake actuating unit, on one hand, to the local brake control units, on the other hand, but also to further elements of the brake system. The individual connections of this radial connection can then form a data connection. A “data connection” can accordingly also comprise a plurality of individual connections which as a whole establish a data connection between a plurality of elements of the brake system.

According to one embodiment, it is provided that the central brake control unit is furthermore to be connected via a data line to the data bus of the vehicle.

The electromechanical wheel brakes can each have, according to one embodiment, an electromechanical actuator. The local brake control units are accordingly designed to actuate the respective electromechanical actuator to generate a braking torque on the basis of the received control signals, so that braking torques can be effectuated on the wheels in operation of the brake system.

According to a embodiment, it is provided that the local brake control units of the wheel brakes are each connected to wheel speed sensors of the wheels associated with the wheel brakes for the transmission of information. In this way, for example, functionalities with respect to an antilock braking control can be implemented for the wheel brakes, which will not be described in greater detail here, however. The brake system can be combined with such an antilock braking control, as described, for example, in document US 2022/0371561 A1, or also with other controls, for example, anti-slip controls. Document US 2022/0371561A1 is hereby incorporated by reference completely in the scope of its disclosure and is made the subject matter of the present application.

The local brake control unit can, according to one embodiment, comprise a controller arrangement which is designed to determine control signals from the actuation information.

The actuation information can detect, for example, an actuation travel x_{Pedal} of the brake pedal and can be supplied to a function block for the driver request detection. Other information can also be considered here, such as a velocity of the pedal actuation v_{Pedal}, which can give information about whether the brake demand is a hazard braking operation, for example. Additionally, according to a refinement, the central brake control unit can also comprise such a controller arrangement, for example, for redundancy.

A brake demand in the form of a vehicle deceleration request Z_{Request} can be generated therefrom in a further function block. The vehicle deceleration request Z_{Request} describes a setpoint deceleration of the vehicle to be effectuated by the wheel brakes. The vehicle deceleration request Z_{Request} can then be supplied to a further function block for determining the brake force distribution, wherein vehicle data such as the weight of the vehicle, the wheelbase, or the center of gravity location of the vehicle can also be taken into consideration.

The corresponding wheel-individual control signal can then be ascertained in operation from the values thus ascertained at least for one wheel. The clamping forces F_{Sp,Request}[Id], with Id=VL, VR, HL, HR, (VL=front left, VR=front right, HL=rear left, HR=rear right), to be applied individually by wheel by the wheel brakes can then be ascertained from the values of the braking forces required to implement the vehicle deceleration request Z_{Request} according to an intended brake force distribution in a function block and transmitted as a control signal to the local brake control units of the wheel brakes.

It is provided that this wheel-individual control signal is converted at least for one wheel into a wheel-individual modified control signal. This is to be understood to mean that the wheel-individual control signal can be modified once again. If the wheel-individual control signal comprises the wheel-individual clamping force F_{Sp,Request}[Id] the wheel-individual modified clamping force F_{Sp, Final_Request}[Id] can be ascertained therefrom as the wheel-individual modified control signal.

This additional modification can contribute to keeping the occurrence of yawing momentum as small as possible. In this way, undesired rotating or rolling of the vehicle around the vertical axis, thus the vertical axis of a vehicle-fixed coordinate system, can be reduced. The wheel-individual modification can consider further factors here, so that—in contrast to the method described in US 2022/0371561 A1—the least possible reduction of the wheel-individual braking force takes place.

The ascertainment of the wheel-individual modified control signal can be based on a wheel-individual scaling factor λ[Id] with Id=VL, VR, HL, HR or comprise a wheel-individual scaling factor λ[Id]. The wheel-individual scaling factor λ[Id] can for example be or comprise a status-dependent wheel-individual scaling factor λ[Id] here. “Status-dependent” is to be understood to mean that at the time of the ascertainment of the wheel-individual modified control signal, the status of the remaining wheel brakes can be detected and taken into consideration. Therefore, further status-dependent signals or influencing factors can also be taken into consideration in the actuation of the individual wheel brakes.

Accordingly, a brake system for a vehicle, wherein the least possible restriction or limiting of the braking torques to be applied per wheel takes place. In this way, the greatest possible level of safety can be provided during a braking operation. This has a positive effect on the driving stability, for example in hazardous situations. Accordingly, it is possible to find an optimum of the at least partially contradictory demands for the lowest possible yawing momentum, on the one hand, and the shortest possible braking distance, on the other hand.

The further influencing factors can comprise, for example, status information about all wheel brakes here, which can be stored or provided as the EMB_Status[Id] with Id=VL, VR, HL, HR. This status information can accordingly comprise wheel-individual signals or further wheel-individual information. For example, this includes information about which wheel brakes are functional and which are not functional or are in a fault status. The status information EMB_Status[Id] can comprise wheel-individual information about the functionality of all wheel brakes of the vehicle, which can be coded accordingly. The status-dependent scaling factor λ[Id] can accordingly provide a wheel-individual value or gradient based thereon for a modification of the braking request of a wheel brake.

In addition, an identifier is proposed, which in operation in the course of the actuation of the wheel brakes contains information about which wheel brake the wheel-individual modified clamping force F_{Sp, Final_Request}[Id] is currently to be determined for.

After selection of the currently observed wheel brake, the scaling factor λ[Id] can be applied to the wheel-individual clamping force F_{Sp,Request}[Id] determined from the brake force distribution. According to one embodiment, the wheel-individual clamping force F_{Sp,Request}[Id] is multiplied by the wheel-individual scaling factor λ[Id] to obtain the corresponding value for the wheel-individual modified clamping force F_{Sp, Final_Request}[Id]. The wheel-individual modified clamping force F_{Sp, Final_Request}[Id] can accordingly be based on the status-dependent scaling factor λ[Id] or comprise it.

In contrast to the gradient mentioned in US 2022/0371561 A1 for reducing the braking forces of all vehicle wheels, the gradient or scaling factor λ[Id] proposed here is formed in greater detail, since it enables a corresponding wheel-individual modification of the braking request for each individual vehicle wheel.

According to an embodiment, the wheel-individual modified control signal or the wheel-individual modified clamping force is additionally limited to a maximum permissible clamping force F_{Sp,Max}[Id].

The maximum permissible clamping force F_{Sp,Max}[Id] can likewise be calculated in a status-dependent manner, thus on the basis of the status information EMB_Status[Id], according to a embodiment.

The wheel-individual modified clamping force F_{Sp, Final_Request}[Id] can therefore be derived from the wheel-individual clamping force F_{Sp, Request}[Id], multiplied by the wheel-individual scaling factor λ[Id], and a subsequent comparison to the maximum permissible clamping force F_{Sp, Max}[Id]. The wheel-individual modified clamping force F_{Sp, Final_Request}[Id] forms the lesser of the two values here. The wheel-individual modified clamping force F_{Sp, Final_Request}[Id] can accordingly be determined according to the following rule:

F_{Sp, FinalRequest}[Id]=Minimum{F_{Sp, Max}[Id], (λ[Id]*F_{Sp, Request}[Id])}.

If, for example, the front left (VL) wheel brake is observed, the following results:

F_{Sp, FinalRequest}[VL]=Minimum{F_{Sp, Max}[VL], (λ[VL]*F_{Sp, Request}[VL])}.

If all wheel brakes are in the fault-free status, thus not in a fault mode, λ[Id]=1.0 applies for the wheel-individual scaling factor and the maximum permissible clamping force F_{Sp, Max}[Id] corresponds to the maximum predeterminable clamping force setpoint value F_{Sp,Sys,Max}[Id] for this wheel brake:

λ[VL, VR, HL, HR]={1.0, 1.0, 1.0, 1.0}

F_{Sp, Max}[VL, VR, HL, HR]={F_{Sp, Sys, Max, VA,} F_{Sp, Sys, Max, VA,} F_{Sp, Sys, Max, HA,} F_{Sp, Sys, Max, HA,}}.

It is assumed here that a different maximum value of the clamping force applies for the front axle (“VA”) than for the rear axle (“HA”). The maximum value of the clamping force can therefore be axle-dependent, for example, but additionally can also be adjusted to the respective vehicle.

The corresponding values can be stored, for example, in a decision matrix, which can comprise information about the driving behavior of the vehicle or about the velocity of the vehicle and corresponding failure rules or fallback rules. This decision matrix may be stored in a memory of the local brake control unit, so that the local brake control unit has direct access thereto. In a refinement, it is also possible to additionally store the decision matrix in a memory of the central brake control unit.

However, it is also possible to provide the corresponding information to the central brake control unit via the data connection to the vehicle or to the vehicle bus. The decision matrix can therefore be constructed and adapted individually by the vehicle. It can correspondingly also be stored in the memory of the vehicle.

In this way, various failure rules or fallback levels (“FBL”=fallback level) can be defined and stored. These can be adapted to the specific vehicle, or can also be adjusted, for example, depending on the user behavior or driving behavior of the vehicle.

As already stated, both the maximum permissible clamping force F_{Sp,Max}[Id] and the wheel-individual scaling factor λ[Id] can be based on the status information EMB_Status[Id].

If it is established on the basis of the status information EMB_Status[Id], for example, that a wheel brake of a rear wheel (HR, HL) has failed, for example, the opposite rear wheel wheel brake can be limited with respect to the maximum clamping force to a value F_{Sp, RFE, Max, HA} defined for this failure, which in turn can depend on the corresponding vehicle or the driving behavior of the vehicle. These values and rules can be stored in the decision matrix.

It is also possible to modify the defined value depending on the vehicle velocity. It is thus possible and intended, for example, that a different yawing momentum be permitted at slow vehicle velocities than at higher vehicle velocities. During slower journeys, for example, at 20 km/h, the yawing momentum builds up more slowly than during faster journeys, for example, at 80 km/h or above. Taking this into consideration, during slower journeys, a greater difference of the clamping force, for example, in the case of a failed wheel brake VL to the diagonally opposite wheel brake HR, can be permitted than at higher velocities. In other words, at lower vehicle velocities, the differences in the clamping force, for example, of the diagonally arranged wheel brakes (VL-HR or VR-HL) do not necessarily result in large or impermissibly high yawing momentum and can therefore be permitted within certain limits.

If a wheel brake of a front wheel (VR, VL) fails, for example, for reasons of driving stability, the clamping force setpoint value of the diagonally arranged wheel brake of a rear wheel (HL, HR) can be multiplied by a scaling factor λ[Id] with λ[Id]<1.0, for example, 0.7, so that the setpoint value is thus reduced. If λ[Id] is near the value zero or is equal to zero, the component of this rear wheel brake is reduced and nearly only braked with another wheel brake, for example, the other diagonal wheel brake. The greater the scaling factor λ[Id] is, the more strongly the wheel brake to which this scaling factor λ[Id] is applied also intervenes accordingly in the braking in this case of fault.

The scaling factor λ[Id] can be a constant value over the entire vehicle velocity. According to one embodiment, however, the scaling factor λ[Id] can in particular also depend on the vehicle velocity V_{Kfz}. The component of the wheel brake arranged diagonally to the failed wheel brake can thus be controlled during a braking operation.

Furthermore, for example, in the case of a braking operation at low velocities, a higher value of λ[Id] can result in more component of the diagonal rear wheel brake in the braking operation and higher braking effect, while at moderate and high vehicle velocities, a small λ[Id] can be necessary from the aspect of driving stability.

According to an embodiment, a controller arrangement or a control module, which causes the local brake control unit to carry out the method steps as explained above, can be stored within the local brake control unit. The controller arrangement can specify which queries or control steps are to be carried out to control a braking torque generated by the force actuator within the current control cycle (loop). Accordingly, the control signals ascertained in the scope of the method can for example be a setpoint clamping force as explained above, but also a setpoint expansion force in the case of a drum brake or a setpoint braking torque. The above-described function blocks can represent components of the controller arrangement.

Not only can the locking of the wheel to which the local brake control unit is connected be prevented by the execution of the method using or by the controller arrangement, but rather the yawing momentum can also be restricted. The controller arrangement can also process signals, which are formed in the or by the local brake control unit, in an embodiment. The local wheel velocity, the local actual clamping force of the electromechanical wheel brake, and the deceleration request can therefore be used to calculate the local setpoint clamping force.

According to an embodiment, still further signals or information are provided to the controller arrangement and used for the determination of the scaling factor λ[Id] and/or the maximum permissible clamping force F_{Sp,Max}[Id]. In addition to the local wheel position and the deceleration request, these can also comprise at least one of the following signals or information:
wheel velocity of at least one of the three further vehicle wheels,
status of at least one of the three further local brake control units or vehicle wheels,
clamping force of at least one of the three further local brake control units or vehicle wheels.

However, not only signals of one of the three further local brake control units or vehicle wheels are used, but rather of all local brake control units or vehicle wheels may be used.

According to a further, embodiment, still further signals are used for the controller arrangement. These can comprise signals or information of the sensor cluster or the inertial sensor system, thus, for example, the yaw rate, the longitudinal acceleration and the lateral acceleration, and/or the steering wheel angle.

The scaling factor λ[Id] can be adapted to the specific situation on the basis of these additional signals or information. Therefore, the brake system is even more fault-tolerant. If clamping forces of the other wheel brakes are absent or are inadequate in the fallback level, for example, the yaw rate and lateral acceleration can be used as a replacement.

In addition to the rule-based systems described here, it is also conceivable and intended that alternatively or additionally self-learning systems or systems having artificial intelligence be used to determine the scaling factor λ[Id] and/or the maximum clamping force F_{Sp,Max}[Id]. The specific driving behavior can also be taken into consideration depending on a driver by such systems, for example.

Thus, the embodiments enable a special parameterization to also be stored, for example, which can depend on the observed fault cases and the vehicle behavior. The brake system can therefore also be designed in an application-specific manner.

Accordingly, the embodiments also comprise a method for controlling the wheel brakes of a motor vehicle, in particular electromechanical wheel brakes, wherein the brake system as defined above is used.

The method provides at least one local wheel brake control unit assigned to the wheel brake, wherein the wheel brake has at least one force actuator driven by an electric motor to generate a braking torque acting on a wheel associated with the wheel brake, wherein the wheel brake control unit is connected via a data connection to a central brake control unit of the motor vehicle, wherein the wheel brake control unit is connected via a data connection to a brake actuating unit, and wherein the brake actuating unit is designed to detect a deceleration request.

Further details are evident from the description of the illustrated exemplary embodiments and the attached claims.

### BRIEF DESCRIPTION OF THE DRAWINGS

In the figures:

FIG. 1 shows a schematic illustration of an exemplary brake system,

FIG. 2 shows an exemplary controller arrangement for determining wheel-individual control signals from actuating information by the central brake control unit in a normal operating mode,

FIG. 3 shows an exemplary controller arrangement for determining wheel-individual modified clamping forces,

FIG. 4 shows an exemplary embodiment having a scaling factor λ[Id] dependent on the vehicle velocity V_{Kfz},

FIG. 5 shows an exemplary embodiment having an overview of the usable signals for determining the wheel-individual modified clamping force, and

FIG. 6 shows still another exemplary embodiment having a sensor cluster for determining the wheel-individual modified clamping force.

### DETAILED DESCRIPTION

In the following detailed description of embodiments, for the sake of clarity, the same reference signs designate substantially identical parts in or on these embodiments. However, for better clarification, the embodiments illustrated in the figures are not always drawn to scale.

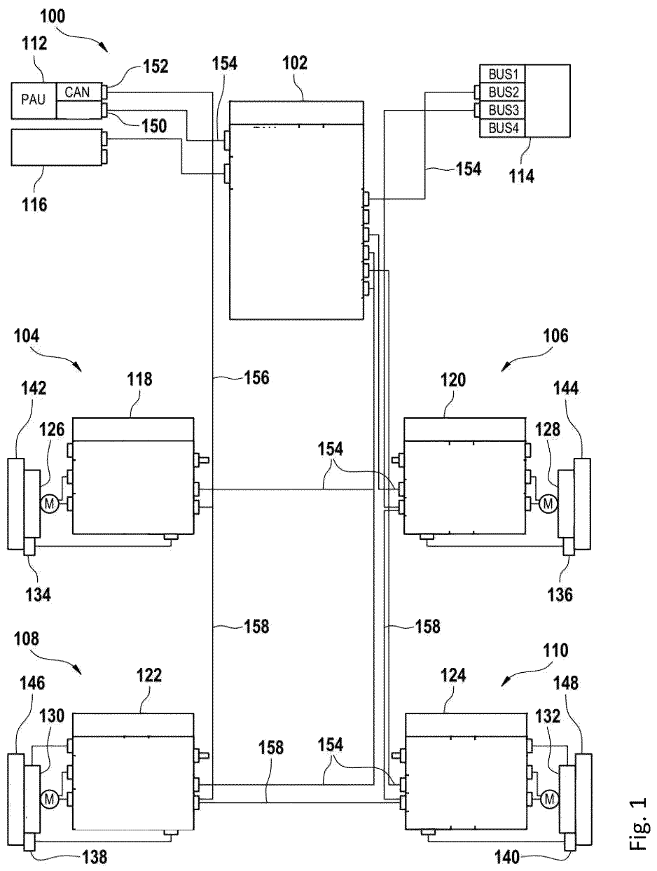

FIG. 1 shows a simplified schematic illustration of an exemplary brake system 100. The brake system 100 comprises electromechanical wheel brakes 104, 106, 108, 110, a brake actuating unit 112, and at least one central brake control unit 102, wherein the wheel brakes 104, 106, 108, 110 each have a local brake control unit 118, 120, 122, 124, the central brake control unit 102 is connected directly to the brake actuating unit 112 and to the local brake control units 118, 120, 122, 124 of the wheel brakes 104, 106, 108, 110 via at least one data connection 154, wherein the central brake control unit 102 in a normal operating mode of the brake system 100 is designed to determine at least one brake demand from the actuating information of the brake actuating unit 112 and to transmit wheel-individual control signals corresponding to the brake demand to the local brake control units 118, 120, 122, 124 of the wheel brakes 104, 106, 108, 110, and wherein in operation, at least for one electromechanical wheel brake 104, 106, 108, 110, the corresponding control signal can be converted into a wheel-individual modified control signal, and wherein the ascertainment of the wheel-individual modified control signal is based on a wheel-individual scaling factor λ[Id] or comprises it.

In this case, the brake system 100 has a central brake control unit 102, four electromechanical wheel brakes 104, 106, 108 and 110, a brake actuating unit 112, a vehicle bus 114, and a parking brake actuating device 116. The wheel brakes each have a local brake control unit 118, 120, 122, 124, an actuator 126, 128, 130, 132 and a wheel speed sensor 134, 136, 138, 140 and are associated with the vehicle wheels 142, 144, 146, 148.

The brake actuating unit 112 is designed here as a brake pedal with a completely mechanical pedal feel simulator (e-Pedal). The brake actuating unit 112 has two independent signal outputs 150, 152, wherein first or second actuating information, respectively, is provided via the signal outputs 150, 152 upon actuation of the brake actuating unit 112 by a vehicle driver. The first actuating information is ascertained by a first sensor assembly and the second actuating information is ascertained by a second sensor assembly. The first and second sensor assemblies may be independent of each other and determine the actuating information on the basis of different physical quantities, so that redundancy is provided.

Two independent signal outputs 150, 152 are not obligatory. Thus, brake systems 100 which only have one signal output 150 are also conceivable and possible.

In the exemplary embodiment, the first signal output 150 is connected via a data connection 154 to the central brake control unit 102. Furthermore, the central brake control unit 102 is connected via the data connection 154 directly to the local brake control units 118, 120, 122, 124 of the wheel brakes 104, 106, 108, 110, to the vehicle bus 114, and to the parking brake actuating device 116. Brake demands, for example, can thereby be transmitted via the vehicle bus 114 when the vehicle is in an autonomous or semi-autonomous driving mode. The data connection 154 accordingly forms a radial connection at the center of which the central brake control unit 102 is arranged.

The central brake control unit 102 is configured to generate control signals for the brake control units 118, 120, 122, 124 of the wheel brakes 104, 106, 108, 110 on the basis of first actuating information received from the brake actuating unit 112 and/or on the basis of brake demands received from the vehicle bus 114 and to transmit these control signals to the brake control units 118, 120, 122, 124 via the data connection. The brake control units 118, 120, 122, 124 are configured to actuate the actuators 126, 128, 130, 132 in accordance with the received control signals so that in operation a braking torque is effectuated at the wheels 142, 144, 146, 148. The wheel speeds of the vehicle wheels 142, 144, 146, 148 are each monitored here by the wheel speed sensors 134, 136, 138, 140 and corresponding wheel speed information is transmitted to the central brake control unit 102 via the first data connection 154. On the basis of the wheel speed information, and optionally considering further information, the central brake control unit 102 can implement brake control functions, such as anti-lock braking control for example.

The second signal output 152 of the brake actuating device 112 is connected directly to the local brake control unit 118 of the wheel brake 104 via a second data connection 156 in this exemplary embodiment. Thus, in a fallback level operating mode of the brake system 100, for example in case of failure of the central brake control unit 102, actuating information can be transmitted directly from the brake actuating unit 112 to the local brake control unit 118 of the wheel brake 104. The design of the second signal output 152 is not obligatory and is solely shown as an example here.

In the exemplary embodiment, the electromechanical wheel brakes 104, 106, 108, 110 are embodied as electromechanical disk brakes; however, they can also be designed as electromechanical drum brakes.

The brake actuating unit 112 is an electrical brake pedal. Actuating information can comprise a degree of actuation of the brake actuating unit 112, for example an actuating angle, an actuating travel, or an actuating force, or the brake demand itself. The brake actuating unit is connected directly to the central brake control unit 102 via at least one data connection 154.

The local brake control unit 118, 120, 122, 124 and/or the central brake control unit 102 comprises a controller arrangement, which is designed to determine control signals from the actuating information.

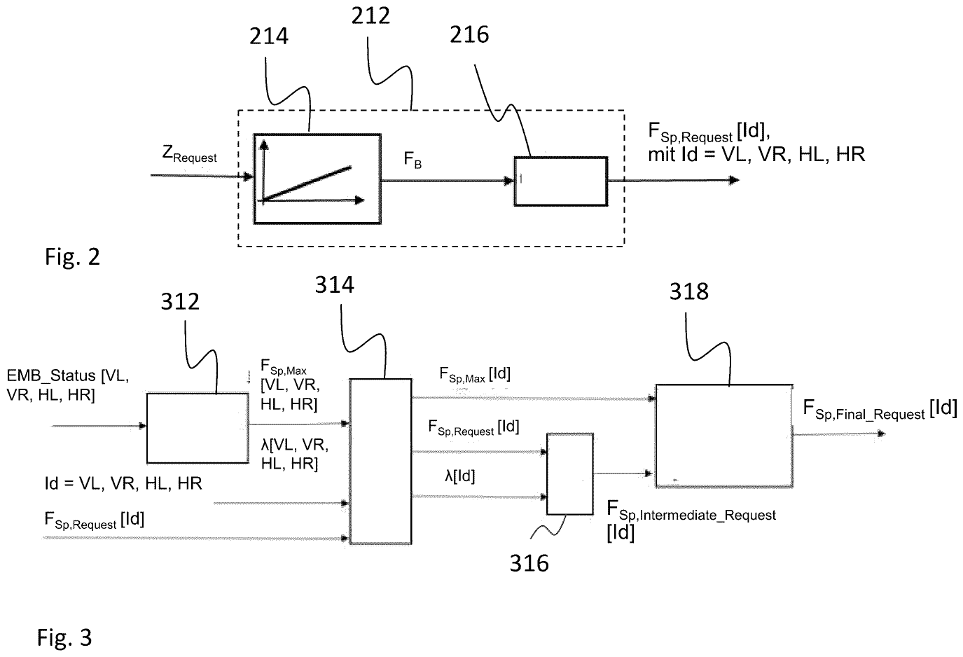

As shown in the exemplary embodiment in FIG. 2, further vehicle data 214, such as the weight of the vehicle, the wheelbase, or the center of gravity location of the vehicle, are considered in a function block 212 in the determination of the brake force distribution. In the case shown in the exemplary embodiment, a permanently predetermined brake force distribution between the front axle and the rear axle of the vehicle is used as the basis. Alternatively, it is also possible that the distribution of the brake force to be applied between front axle and rear axle of the vehicle is ascertained depending on the strength of the vehicle deceleration request Z_{Request}. From the values thus ascertained of the brake forces FB of the brake force distribution required to implement the vehicle deceleration request Z_{Request}, the clamping forces F_{Sp,Request}[Id] to be applied by the wheel brakes 104, 106, 108, and 110 are then ascertained in function block 216.

It is provided that the wheel-individual control signal or the wheel-individual clamping force F_{Sp,Request}[Id] to be applied is converted at least for one vehicle wheel, and optionally for all vehicle wheels, into a wheel-individual modified control signal or into a wheel-individual modified clamping force F_{Sp, Final_Request}[Id].

FIG. 3 shows for this purpose an exemplary controller arrangement for determining wheel-individual modified clamping forces F_{Sp, Final_Request}[Id] on the basis of the ascertained clamping forces F_{Sp, Request}[Id] to be applied. Accordingly, the occurrence of yawing momentum can be reduced by this additional modification with the least possible restriction of the braking torques to be applied at the same time. In this way, undesired rotating or rolling of the vehicle around the vertical axis, thus the vertical axis of a vehicle-fixed coordinate system, can be further reduced.

As can be seen in FIG. 3, further influencing factors are taken into consideration for the wheel-individual modification. These further influencing factors, for example, status information EMB_Status[VL, VR, HL, HR] about all wheel brakes, are provided to a function block 312. This status information comprises the wheel-individual information about the functionality of the individual wheel brake 104, 106, 108, and 110. Based thereon, the scaling factor λ[VL, VR, HL, HR] and the maximum value F_{Sp, Max}[VL, VR, HL, HR] are determined and provided to a further function block 314.

For this purpose, information about the driving behavior of the vehicle or about the velocity of the vehicle and corresponding failure rules or fallback rules can also be taken into consideration.

Subsequently, the wheel-individual scaling factor λ[Id] and the wheel-individual maximum value F_{Sp, Max}[Id] are ascertained in the function block 314 on the basis of the identifier, which indicates for which wheel brake 104, 106, 108, and 110 to be actuated the wheel-individual modified clamping force F_{Sp, Final_Request}[Id] to be ascertained is to be determined.

The wheel-individual clamping force F_{Sp, Request}[Id] is then multiplied in a further function block 316 for the selected wheel brake with the wheel-individual scaling factor λ[Id]. The value thus obtained is also designated in the exemplary embodiment of FIG. 3, solely for clarification, as an intermediate value for the wheel-individual modified clamping force F_{Sp, Intermediate_Request}[Id].

Finally, in still a further function block 318, the result value F_{Sp, Final_Request}[Id] is ascertained from the intermediate value for the wheel-individual modified clamping force F_{Sp, Intermediate_Request}[Id] and the wheel-individual maximum value F_{Sp, Max}[Id], wherein the wheel-individual modified clamping force F_{Sp, Final_Request}[Id] represents the lesser of the two values.

The wheel-individual modified clamping force F_{Sp, Final_Request}[Id] is accordingly determined according to the following rule:

F_{Sp, FinalRequest}[Id]=Minimum{F_{Sp, Max}[Id], (λ[Id]*F_{Sp, Request}[Id])}.

The wheel-individual modified clamping force F_{Sp, Final_Request}[Id] shown in FIG. 3 therefore represents the clamping force which is to be set at the correspondingly selected wheel brake 104, 106, 108, and 110.

The function status of each of the individual wheel brakes 104, 106, 108, and 110 is defined in the signal or the status information EMB_Status[Id]. In the simplest case, classifications such as “fully functional” or “faulty/switched off” can stand here. Intermediate classifications such as “only half of the force available” or “reduced dynamics”, or the like, are also possible here. On the basis of this status information, from a driving-dynamics aspect and to avoid or reduce yawing momentum, the scaling factors λ[Id] and the limiting value F_{Sp,Max}[Id] are determined for all, particular.g. the still functional wheel brakes.

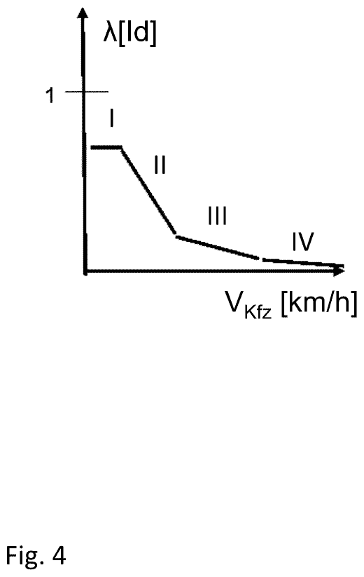

If, for example, the wheel brake VL is no longer functional, the predetermined force of the diagonal wheel brake HR, which is supposed to be still fully functional in this example, is scaled by means of the scaling factor λ[Id] to smaller values. This can also take place depending on the vehicle velocity, as shown in more detail hereinafter in the exemplary embodiment of FIG. 4.

However, it is also possible in the simplest case to deactivate the functioning wheel brake HR during this braking operation by means of λ[HR]=0.0.

Both the maximum permissible clamping force F_{Sp, Max}[Id] and the wheel-individual scaling factor λ[Id] are thus based on the status information EMB_Status[Id].

If it is established on the basis of the status information EMB_Status[Id], for example, that a wheel brake of a rear wheel (HR, HL) has failed, for example, the opposite rear wheel wheel brake can be limited with respect to the maximum clamping force to a value F_{Sp, RFE, Max, HA} defined for this failure, which in turn can depend on the corresponding vehicle or the driving behavior of the vehicle.

It is also possible, for example, to modify the stored value F_{Sp, RFE, Max, HA} depending on the vehicle velocity (“FBL”=fallback level, “HA”=rear axle). It is thus possible and intended, for example, that a different yawing momentum be permitted at slow vehicle velocities than at higher vehicle velocities.

If a wheel brake of a front wheel (VR, VL) fails, for reasons of driving stability, the clamping force setpoint value of the diagonally arranged wheel brake of a rear wheel can be multiplied by a scaling factor λ[Id] with λ[Id]<1.0, for example, 0.7, so that the setpoint value is thus reduced. If λ[Id] is near the value zero or is equal to zero, the component of this rear wheel brake is reduced and nearly only braked with the other diagonal wheel brake. The greater the scaling factor λ[Id] is, the more strongly the wheel brake to which this scaling factor λ[Id] is applied also intervenes accordingly in the braking in this case of fault.

The function blocks 312, 314, 316, and/or 318 can comprise corresponding controller arrangements or can be part of a controller arrangement. The decision matrix can be stored in a memory associated with the controller arrangement. The decision matrix may be stored in the memory of the local brake control unit 118, 120, 122, 124, but can also additionally be implemented in the central brake control unit 102.

The scaling factor λ[Id] can be a constant value over the entire vehicle velocity. With fully usable wheel brakes 104, 106, 108, and 110, the scaling factor λ[Id] can accordingly be formed as follows:

λ[VL, VR, HL, HR]={1.0, 1.0, 1.0, 1.0}

According to one embodiment, however, the scaling factor λ[Id] can also depend on the vehicle velocity V_{Kfz}. The component of the wheel brake arranged diagonally to the failed wheel brake can thus be controlled better during a braking operation.

FIG. 4 shows for this purpose an exemplary embodiment having a scaling factor λ[Id]=f(V_{Kfz}) dependent on the vehicle velocity V_{Kfz}, In this exemplary embodiment, the vehicle velocity V_{Kfz} is divided solely for illustration into four different velocity ranges I, II, III, IV having correspondingly different scaling factors λ[Id]. In a first velocity range I, the scaling factor λ[Id] is kept constant here. This is followed by a second velocity range II having a linearly decreasing scaling factor λ[Id]. In the following two velocity ranges III and IV, the scaling factor λ[Id] is likewise linearly decreasing, but with lesser slope in each case. This design of the scaling factor λ[Id] has the result that the effectuated intervention or the restriction of the braking torque results more strongly the faster the vehicle drives. In other words, at lower velocity a lesser restriction takes place and at higher velocity a greater restriction takes place. It is apparent to a person skilled in the art that this course of a scaling factor λ[Id] dependent in this way only represents one exemplary embodiment and of course other relationships and rules between the scaling factor λ[Id] and the vehicle velocity V_{Kfz} can also be stored and applied.

Furthermore, for example, in the case of a braking operation at low velocities, a higher value of λ[Id] can result in more component of the diagonal rear wheel brake in the braking operation and higher braking effect, while at moderate and high vehicle velocities, a small λ[Id] is necessary from the aspect of driving stability. The design of the scaling factor λ[Id] can additionally also depend on whether the respective vehicle wheels are associated with the front axle or the rear axle.

In this exemplary embodiment, the control arrangement, which causes the brake control unit to carry out the method steps as explained above, is stored within the central brake control unit 102 for this purpose. The controller arrangement specifies which queries or control steps are to be carried out to control a braking torque generated by the force actuator within the current control cycle (loop). In the above-described exemplary embodiments, the control signals ascertained in the scope of the method involve the setpoint clamping force. Of course, these can also involve a setpoint expansion force or a setpoint braking torque.

The occurrence of yawing momentum can be kept as small as possible or prevented in the ideal case by the execution of the method using or by the controller arrangement. According to a first embodiment, the controller arrangement primarily uses signals here which are formed on or in the local brake control unit 118, 120, 122, 124. The local wheel velocity, the local actual clamping force of the electromechanical wheel brake 104, 106, 108, 110, and the deceleration request is used to calculate the local setpoint clamping force.

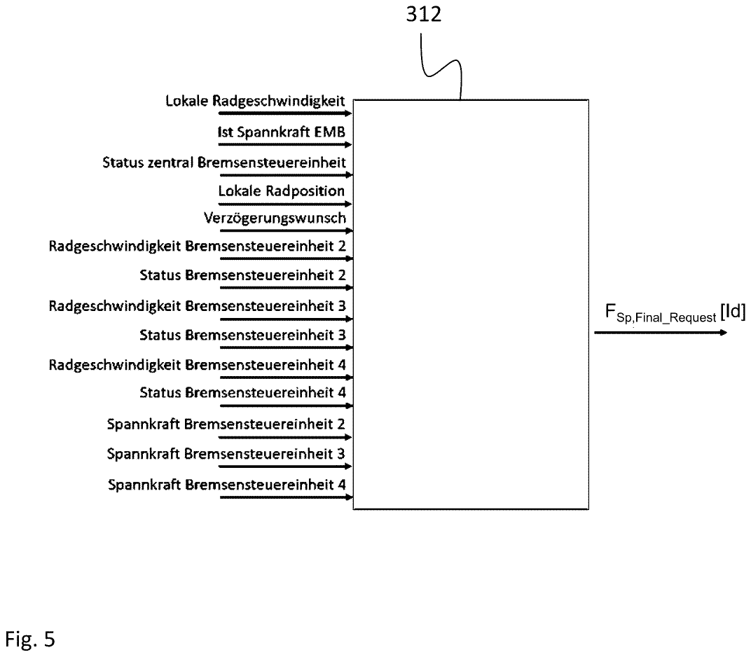

In the exemplary embodiment, the controller arrangement can use still further signals and information for the determination of the scaling factor λ[Id] and/or the maximum permissible clamping force F_{Sp,Max}[Id]. FIG. 5 shows for this purpose an exemplary embodiment having an overview of further usable signals or information for determining the wheel-individual modified clamping force. In addition to the local wheel position and the deceleration request, these signals comprise:
wheel velocity of at least one of the three further vehicle wheels 142, 144, 146, 148,
status of at least one of the three further local brake control units 118, 120, 122, 124 or vehicle wheels 142, 144, 146, 148, and/or
clamping force of at least one of the three further local brake control units 118, 120, 122, 124 or vehicle wheels 142, 144, 146, 148.

For the brake system 100, it is intended that not only signals of one of the three further local brake control units 118, 120, 122, 124 or vehicle wheels 142, 144, 146, 148 are used, but rather of all local brake control units 118, 120, 122, 124 or vehicle wheels 142, 144, 146, 148.

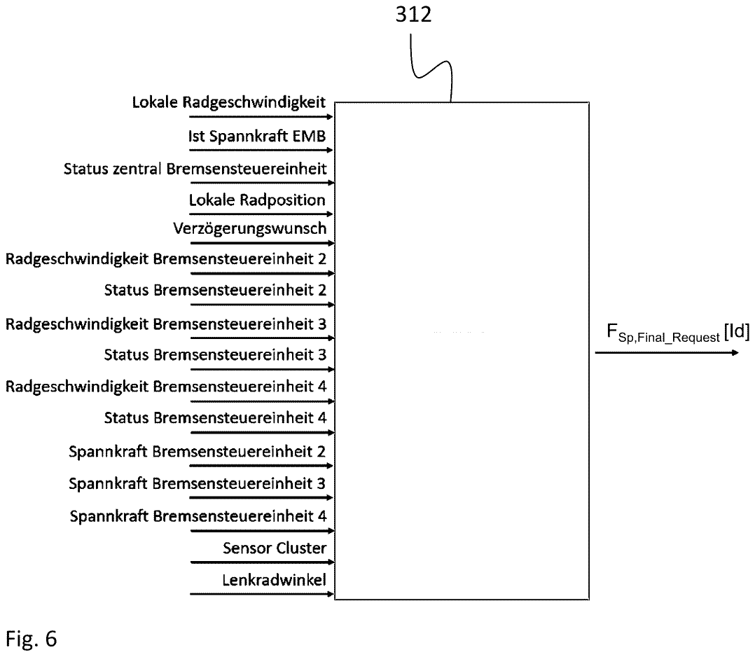

According to a further embodiment, as shown in FIG. 6 still further signals are used for the controller arrangement. These can comprise signals or information of the sensor cluster and/or the steering wheel angle.

The scaling factor λ[Id] can be adapted to the specific situation on the basis of these additional signals or information. Thus, the brake system is even more fault-tolerant. If clamping forces of the other wheel brakes are absent or are inadequate in the fallback level, for example, the yaw rate and/or lateral acceleration can be used as a replacement.

For the data processing within the controller arrangement, for example, a reference velocity of the vehicle can be concluded from the sum of the wheel speeds of the individual vehicle wheels 142, 144, 146, 148. For example, a status of the local brake control units 118, 120, 122, 124 can additionally be queried here, wherein only those wheel speeds are considered in the determination of the reference velocity which were transmitted from a brake control unit 118, 120, 122, 124, or the status of which indicates the full functionality of the wheel brake.

The specific determination of the reference velocity, thus the specific calculation rule, can furthermore depend here on the position of the vehicle at which the wheel brake is located.

According to a further embodiment, it can furthermore be provided that in the ascertainment of the vehicle reference velocity and/or a vehicle deceleration and/or change of the rotation behavior of a vehicle wheel, a vehicle reference velocity and/or vehicle deceleration and/or change of the rotation behavior of the vehicle wheel determined at an earlier time is taken into consideration. In this way, short-term swings of the ascertained values can be filtered out, so that a harmonic control behavior is achieved.

Furthermore, the reliability of the method can be increased in that according to a further embodiment, if the vehicle reference velocity is determined by a wheel brake control unit assigned to a rear wheel, the maximum individual wheel velocity of the vehicle wheels is adopted as the vehicle reference velocity.

Similarly thereto, it is provided according to still a further embodiment that the ascertainment of the rotation behavior of the wheel associated with the wheel brake includes ascertaining a change of the wheel speed of the wheel, wherein a classification of the deceleration behavior is derived from the ascertained change of the wheel speed and wherein the classification of the deceleration behavior is taken into consideration in the determination of the control mode.

If, for example, the right rear wheel HR is observed, according to the invention, the clamping force of the left rear wheel can be incorporated in the calculation of the clamping force specification for the right rear wheel. Thus, for example, to achieve the highest possible stability of the vehicle, the clamping force specification can be reduced to the level of the left rear wheel, added to an offset value, which is selected depending on the level of the yawing momentum to be permitted. This can take place if the clamping forces of the right and left rear wheels have a high difference from one another.

The embodiments enable a special parameterization to also be stored, for example, which can depend on the observed fault cases and the vehicle behavior. The brake system can therefore also be designed in an application-specific manner.

The embodiments also provide a method for controlling the wheel brakes 104, 106, 108, 110 of a motor vehicle, for example of electromechanical wheel brakes, wherein a brake system 100 as described above is used.

1. A brake system for a motor vehicle comprising:
a plurality of electromechanical wheel brakes,
a brake actuating unit,
at least one central brake control unit connected directly to the brake actuating unit via at least one data connection, and
a plurality of local brake control units wherein the central brake control unit is connected to the plurality of local brake control units via the at least one data connection, and wherein the wheel brakes each have one of the plurality of local brake control units,
wherein in a normal operating mode of the brake system the central brake control unit is designed to determine at least one brake demand from actuating information of the brake actuating unit and to transmit wheel-individual control signals corresponding to the at least one brake demand to the plurality of local brake control units,
wherein in operation, for at least one electromechanical wheel brake of the plurality of wheel brakes, the corresponding control signal is converted into a wheel-individual modified control signal, and
wherein the wheel-individual modified control signal is based on a wheel-individual scaling factor.

2. The brake system as claimed in claim 1, wherein each of the plurality of electromechanical wheel brakes are electromechanical disk brakes or electromechanical drum brakes.

3. The brake system as claimed in claim 1, wherein the brake actuating unit comprises an electrical brake pedal.

4. The brake system as claimed in claim 1, wherein the wheel-individual control signal comprises the wheel-individual clamping force and the wheel-individual modified control signal comprises the wheel-individual modified clamping force.

5. The brake system as claimed in claim 1, wherein the ascertainment of the wheel-individual scaling factor considers the functionality of at least one further wheel brake of the plurality of wheel brakes.

6. The brake system as claimed in claim 1, wherein the wheel-individual scaling factor depends on the vehicle velocity.

7. The brake system as claimed in any claim 1, wherein the wheel-individual scaling factor is constant over the entire vehicle velocity.

8. The brake system as claimed in claim 1, wherein the wheel-individual modified clamping force is limited to a maximum permissible clamping force of the wheel brake.

9. The brake system as claimed in claim 1, wherein the wheel-individual modified clamping force is determined according to:
F_{Sp, FinalRequest}[Id]=Minimum{F_{Sp, Max}[Id]}.

10. The brake system as claimed in claim 1, wherein information about the driving behavior of the vehicle or about the velocity of the vehicle and corresponding failure rules or fallback rules is taken into consideration for the calculation of the maximum permissible clamping force.

11. The brake system as claimed in claim 1, wherein at least one of the plurality of local brake control units and the central brake control unit comprises a controller arrangement for the calculation of at least one of the scaling factor and the maximum permissible clamping force.

12. The brake system as claimed in claim 1, wherein at least one of the plurality of local brake control unit and the central brake control unit comprises a decision matrix for the ascertainment of at least one of the wheel-individual scaling factor and the maximum permissible clamping force which is stored in a memory.

13. The brake system as claimed in claim 1, wherein at least one of the plurality of local brake control unit and the central brake control unit comprises a self-learning system for the ascertainment of at least one of the wheel-individual scaling factor and the maximum permissible clamping force.

14. The brake system as claimed in claim 1, wherein ascertainment of at least one of the wheel-individual scaling factor and the maximum permissible clamping force further comprises using at least one of:
wheel velocity of a wheel and at least one further local vehicle wheel of a plurality of wheels,
status of at least one of the further local brake control units of the plurality of local brake units,
status of at least one of the further local wheels of the plurality of local wheels,
clamping force of at least one of the further local brake control units of the plurality of local brake units,
clamping force of at least one of the further local wheels of the plurality of local wheels,
information from a sensor cluster, and
a steering wheel angle.

15. A method for controlling an electromechanical wheel brake of a motor vehicle comprising:
determining with a central brake control unit at least one brake demand from actuating information of a brake actuating unit;
transmitting wheel-individual control signals corresponding to the at least one brake demand to a plurality of local brake control units; and
converting the wheel-individual control signal for at least one electromechanical wheel brake of a plurality of wheel brakes into a wheel-individual modified control signal, wherein the ascertainment of the wheel-individual modified control signal is based on a wheel-individual scaling factor.

16. The brake system as claimed in claim 1, wherein the calculation of at least one of the scaling factor and the maximum permissible clamping force considers the local wheel position and the deceleration request
